(19) United States
(12) Patent Application Publication
(10) Pub. No.: US 2007/0106556 A1
(43) Pub. Date: May 10, 2007

(54) Joint Redemption Account

(75) Inventors: Adrienna M. Edwards, Brooklyn, NY (US); Mary C. Hines, New York, NY (US); David Kroner, Woodcliff Lake, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Co., Inc., a New York Corporation

(21) Appl. No.: 11/613,596

(22) Filed: Dec. 20, 2006

Related U.S. Application Data
(63) Continuation-in-part of application No. 11/270,670, filed on Nov. 10, 2005.

(51) Int. Cl. G06Q 30/00

(52) U.S. Cl. 705/14

(57) ABSTRACT

A method of combining reward points from multiple accounts within the same rewards program into a joint redemption account. The method comprises establishing an on-line joint redemption or community reward account to which program members can contribute rewards points; allowing two or more contributing program members to contribute rewards points from their respective rewards program accounts to the community reward account; redeeming the points from the community reward account for a predetermined reward; and withdrawing the redeemed points from each contributing program member's rewards account according to that program member's contribution to the community reward account.

### CROSS-REFERENCE TO RELATED APPLICATION

This is a continuation-in-part of application Ser. No. 11/270,670, filed Nov. 10, 2005, the disclosure of which is incorporated herein in its entirety as though set forth in full below.

### BACKGROUND OF THE INVENTION

1. Field of the Invention

This invention generally relates to cumulating points from multiple individual accounts into a joint account for purposes of redemption.

2. Background

Many loyalty or affinity programs, such as credit/charge card companies, hotel and lodging companies, airlines, retail stores, and the like, have rewards programs whereby a member of the program can accumulate points by charging purchases on the credit/charge card, by staying at the hotel or lodging for a specified number of nights, by taking flights on the airline, etc. The points accumulated by the program member can be exchanged for a variety of rewards, such as products, services, hotel stays, airline flights, etc.

To attract and keep customers, many merchants have established customer rewards programs. Each time a customer purchases the merchant's goods or services, including, but not limited to, usage of a credit or charge card services to purchase store products, airline tickets, hotel stays, etc., the customer who is a member of the rewards program will accrue points in the program commensurate with the value of the purchase.

Loyalty or affinity programs are designed to encourage and increase a particular customer behavior by offering a variety of rewards that can be redeemed using accumulated loyalty rewards points. Typically, a customer can redeem his/her loyalty rewards points for rewards, such as merchandise, gift certificates, charitable donations, cash, or points/miles in a participating partner loyalty or affinity program. In a typical redemption scenario, as long as the customer has adequate points, he/she can redeem a fixed number of loyalty rewards points for a particular reward.

Over time the program member may accrue thousands or tens of thousands of points. The points can be redeemed by the program member for various rewards, such as products like cameras, televisions, radios, etc., for airline tickets, or hotel stays, car rentals, etc.

Most, if not all, rewards programs restrict the transfer of rewards points. Most rewards program agreements state that the points are not the property of the program member, they cannot be freely transferred, and they can only be accrued by an individual program member. There are strict prohibitions against selling or bartering points. Almost all rewards program agreements contain language that specifically prohibits such transfers. One such program agreement contains the following language:
Accrued points and miles do not constitute property of the member. Points accrued by a . . . Rewards member are for the member's benefit only and may not be transferred to anyone. Points are transferable to a legal spouse only in the case of documented death of the member. Points are not transferable to another person for any other reason, including divorce or inheritance.
Another program agreement contains the following restrictions: The accumulation of points does not entitle members to any vested rights with respect to points, miles, rewards, or program benefits. In accumulating points, members may not rely upon the continued availability of any reward or reward level.

Still another (airline) rewards program agreement contains the following statement:
Accrued mileage and certificates do not constitute property of the member. Neither accrued mileage nor certificates are transferable (i) upon death, (ii) as part of a domestic relations matter, or (iii) otherwise by operation of law.

Many rewards programs do not allow points to be transferred from one member account to another under any circumstances. A few rewards programs permit a limited right of transfer of points from one member account to another member account. Usually, the transferee account must be that of a spouse or other family member. In essentially all known cases, once the transfer is made, the points cannot be reclaimed by the transferor and returned to the transferor's account.

There are many times, however, when a group of rewards program members would like to pool their rewards points to achieve greater “buying” power. For example, a club or church organization may want to redeem points for a common item, such as a vacation trip for the winner of a contest, or to acquire a new television for a common room in a club house. Another example is a program member who is planning a honeymoon. The program member would like to allow friends and family members to be able to contribute program points to their account to enable the program member to redeem the points for airline tickets, hotel stays, car rentals, and the like. Typically the individual club members who are also rewards program members would not have enough points in their individual accounts to redeem them for the desired item. However if they were able to combine their points into a joint account, the jointly accumulated points would be sufficient to redeem the desired item.

It would be very desirable to permit rewards program members to aggregate their points in a single joint account within the rewards program. This would give that group of members greater buying power for a reward that might be beyond the reach of any one of the program members. It would also be desirable to permit program members to withdraw from the joint account before points are redeemed or to retain their contributed points in the event the joint account is terminated prior to redemption of the accumulated points.

### BRIEF SUMMARY OF THE INVENTION

The present invention overcomes some or all of the problems associated with previous rewards programs by providing a method of combining reward points from multiple accounts within the same rewards program into a joint redemption account. The method comprises establishing an on-line joint redemption or community reward account to which program members can contribute rewards points; allowing two or more contributing program members to contribute rewards points from their respective rewards program accounts to the community reward account; redeeming the points from the community reward account for a predetermined reward; and withdrawing the redeemed points from each contributing program member's rewards account according to that program member's contribution to the community reward account.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart of a joint redemption program in which creation and participation are accomplished entirely on-line.

FIG. 2 is a flow chart showing the detailed steps of establishing a community reward.

FIG. 3 is a flow chart of a joint redemption program in which participation in a joint redemption reward is conducted through a program agent.

The present invention will be described with reference to the accompanying drawings. The drawing in which an element first appears is typically indicated by the leftmost digit(s) in the corresponding reference number.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Terminology

The term “merchant” as used herein shall mean any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, an online merchant, or the like.

A “transaction account” as used herein refers to an account associated with an open account card or a closed account card system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a card that may only be accepted at, a clothing retailer, such as a Saks Fifth Avenue® store.

The term “rewards program” (RP) and/or “awards program” and/or the plural form of these terms are used interchangeably throughout this description to denominate a program in which points are awarded for money spent by a program member with a merchant, such as by charging purchases to a credit/charge card, purchasing and using airline tickets or rail travel tickets, paid hotel stays, car rentals, etc.

The terms “program member” (PM), “contributing program member” (CPM), “card member” (CM), “account holder”, “consumer”, “customer,” “participant,” and/or the plural form of these terms are used interchangeably throughout herein to refer to a person or entity who is the owner of a transaction account.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder, radio frequency card or payment statement).

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

Program Embodiments

The present invention permits a group of rewards program members to aggregate their points in a single joint redemption (or community reward) account within a rewards program. This gives the group greater buying power for a reward that might be beyond the reach of any individual one of the program members. The present invention also permits program members to withdraw from the joint account before points are redeemed or to retain their contributed points in the event the joint account is terminated prior to redemption of the accumulated points. The present invention accomplishes these desired results in the following way.

A merchant having a rewards program establishes a “community rewards” website. The community rewards website may be an area on the main rewards program website devoted to community rewards or it may be a link to an associated rewards program community rewards website that lists active “community rewards.” The rewards program website and the community rewards portion or link are accessible by all members of the merchant's rewards program.

Any eligible program member can set up a specific “community reward” (CR) on the community rewards website. The program member who sets up the community reward will typically, although not necessarily, be the administrator of that community reward. The administrator has the option to allow all members of the merchant's rewards program to participate in the community reward or to allow only a selected subset of the entire rewards program membership to participate in the particular community reward. This function can be controlled by the merchant.

It will be understood that more than one community reward can be established on the community rewards website. Each community reward may, but would not necessarily, have separate eligibility requirements unique to that particular community reward. For example, a church sponsored community reward might be set up to purchase an airline ticket to bring a deserving family from a foreign country to the United States. A club sponsored community reward may be used to purchase a large screen TV for a clubhouse common room. The community reward may, but need not, be established in such a way that only members of the church or club would be eligible to contribute points to the community reward. Eligible participants would be given a password or unique community reward ID number to obtain access to the community reward. Other examples of community rewards would be apparent to those skilled in the relevant arts.

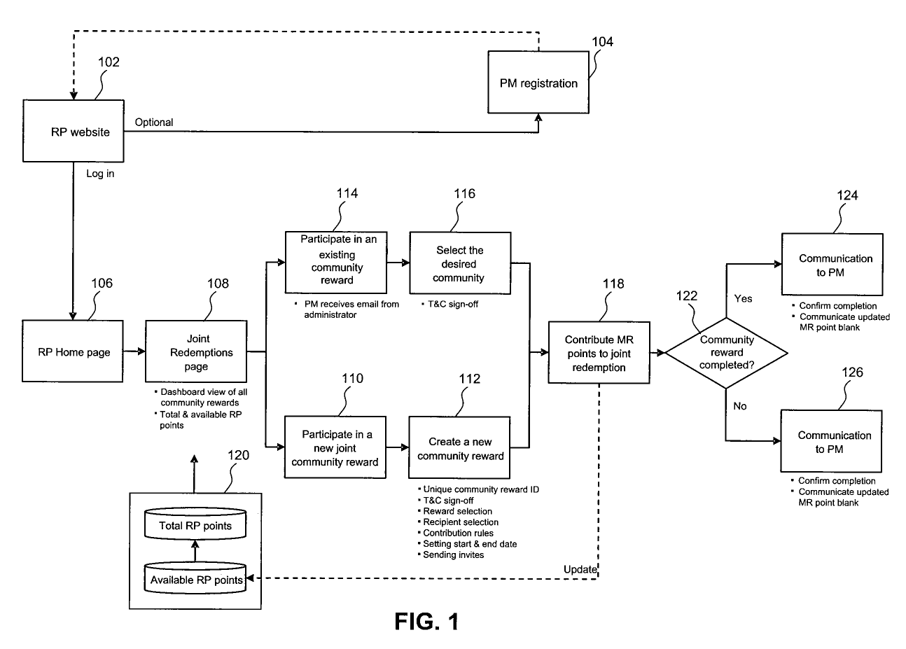

FIG. 1 is a flow chart showing the on-line administration and participation in a community reward program. In step 102, an account holder accesses a rewards program (RP) website. If the account holder is not already a registered member of the rewards program, he/she must register at step 104. After the initial registration, the account holder, now a registered program member (PM), can bypass step 104 and log directly into the RP website, in a manner well known to those skilled in the relevant arts.

Once the PM has accessed the RP website, he/she is generally taken to the RP website home page in step 106. From there, at step 108, the PM can access the joint redemption (JR) home page. In one embodiment, the PM will be taken to an introductory page that explains the benefits of the JR program and how to establish a community reward (CR). Alternatively, if the PM is experienced with CRs, they may be taken directly to a CR setup page that may or may not contain a list of all community rewards in which the PM has participated with a section for establishing a new CR. In another embodiment, no open CRs are listed on that page.

In either case, at the CR set up page, the PM has the ability to establish a new CR. At step 110, the PM can elect to establish a new CR. At step 112, the PM (hereafter called the Administrator PM) establishes a new CR with at least one or more of the following attributes:
A unique ID or name for the community reward.
A sign off check box for the terms and conditions (T's&C's) for the community reward program (typically the T's&C's are established by the rewards program merchant).
A description of the reward to be redeemed from a specific list of products and/or services available from the merchant.
The point value goal of the community reward. A big screen television, for example, might have a point value of 200,000 points. In other words, to acquire the big screen television would require redeeming 200,000 points. To redeem an international airline ticket may require 60,000 points.
The end date for contributions.
The identity of the community reward administrator and owner of the community reward (if not the program member who sets up the community reward) who could be contacted by the merchant if there are any questions concerning the community reward or the disposition of the redeemed reward.
The names and email addresses or other contact information of those individuals (who may or may not be PMs) the administrator would like to invite to contribute to the community reward.
A suggested contribution amount for each invitee.
a minimum contribution amount
The identity of the reward recipient.

When the community reward is created, a unique ID number is generated.

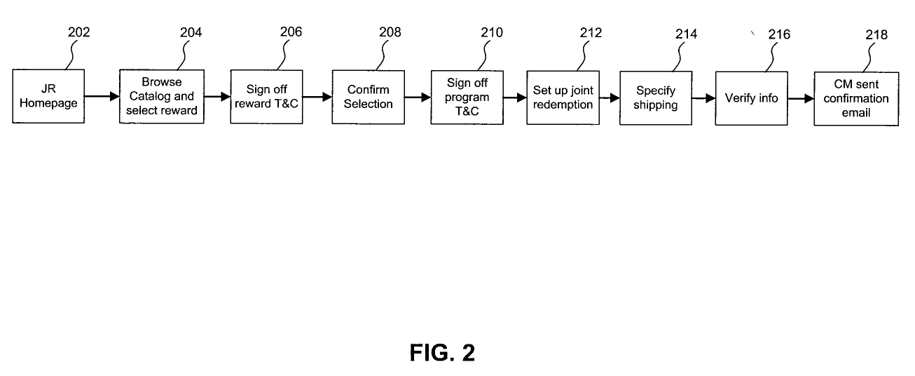

FIG. 2 is a flow chart showing the detailed steps for establishing a CR. At step 202, the Administrator PM logs onto the JR homepage. From there, the Administrator PM can access the on-line catalog at step 204 to select a reward. To complete the reward selection, the Administrator PM must first sign off on the reward T&C's at step 206 and then confirm the selection at step 208. Once the reward has been selected, the Administrator PM can create the CR by first signing off on the program T&C's at step 210. Next, at step 212, the Administrator PM will create the CR; the reward will be given a name (e.g., “Grandma's birthday gift”); the Administrator PM will indicate how many of the Administrator PM's available points they want to contribute to the CR; the Administrator PM will indicate how many other individuals (who may or may not be PMs) will be invited to participate; and the Administrator PM will provide the e-mail addresses of the other invited individuals.

Once the initial CR set up information has been provided, the Administrator PM will provide shipping information at step 214, if the CR requires shipping to its destination. If there is a charge for shipping, the Administrator PM may be required to provide a financial instrument identifier (e.g., credit card number) for the charge. If the shipping address is not the same as the billing address, the Administrator PM will be required by the system to provide a Secure Identification Device (SID) number. If the reward is being sent to a Recipient other than the Administrator PM (that is, an alternate Recipient), the Administrator PM has the option to send a notification email to the alternate Recipient by providing the alternate Recipient's email address and personalized message. As is well known to those skilled in the relevant arts, this is typically a three or four digit number printed on the financial instrument that is not part of the financial instrument identifier.

Following that, at step 216, the Administrator PM will be asked to verify the CR, including the reward, the addresses of the other invitees, the shipping address, and any other information relevant to the CR. Upon verification, the CR will be assigned a unique CR ID by the system. In addition, the system will automatically calculate a suggested point contribution for each CR participant. The suggested point contribution (typically, the same amount will apply for each invitee) is calculated at step 212 when the Administrator PM contributes points and identifies the email addresses of Invitees. Typically, although not necessarily, this is done by dividing the total remaining number of points required for the reward (after the Administrator PM's contribution) by the number of invitees.

Finally, at step 218, the Administrator PM is sent an e-mail confirmation that the CR has been established.

Thereafter, when the Administrator PM logs on to the JR website and to the particular CR, they will be taken to an administrative screen that will allow them to edit the shipping information, add or remove invitees, add more contributions, or cancel the CR entirely.

It is possible that not all invitees will be eligible to participate in the CR. If an invitee is not currently a member of the rewards program, not in good account standing with the merchant, or does not have a sufficient number of rewards points in their account, they will not be able to contribute to the CR. In that case, the Administrator PM may elect to add more invitees and/or may decide to increase the amount of the suggested contribution for the remaining eligible invitees.

Once the community reward is established, the system sends out invitations, typically e-mail or other electronic mail notices, to those individuals identified by the Administrator PM as potential contributors. The invitation will typically provide information about the reward, such as, but not limited to, the total points contribution required, a suggested point contribution, the ending date for contributing points, the recipient of the community reward, and the system generated unique CR ID number.

Once the invitees have been notified that a CR has been established, the invitees can log on to the JR website. In one exemplary embodiment, the invitation will instruct the invitee to log in to their financial instrument account. Since only invitees having an account with the merchant with which the rewards program is associated are eligible to participate, the system is self-selecting as to which invitees can participate in the CR.

Once the invitee logs in to their account, the account page will contain a space to insert the CR ID that is contained on the invitation. The invitee is then taken to the web page for the specific CR to which the invitee has been given an invitation to contribute.

Typically only invited PMs can participate in the CR. In one embodiment, CR participation is open only to a limited number of PMs. For example, the system may limit participation to 15 or 20 PMs at the most. One skilled in the relevant arts will understand that these numbers are not limiting, but are merely exemplary. However, in one example, any PM who has access to the CR ID number can access the CR page and contribute points to the CR.

Once the CR is selected, the PM will then enter the number of reward points the PM intends to contribute to the community reward. The PM may also be required to agree to the CR T&C's at this point, by checking the appropriate “Accept” box, as is well known to those skilled in the relevant art. Typically, the system will ask the contributing PM to confirm the number of points to be contributed to the selected community reward. Typically, at this point the PM may be required to go through a SID verification. Once the PM confirms the contribution, then at step 118, the system may withdraw those points from the PM's account and deposit them directly into the CR account. Alternatively, the system may withdraw the points from the PM's account and deposit them into a master escrow account with points from all open CR accounts until they are ready to be redeemed. In a still further alternative, the system may put a hold on those points to prevent the PM from withdrawing those points for another purpose, but would not actually withdraw the points from the PM's account. Whether the points are immediately withdrawn or left in the PM's account pending a final determination of the CR may, for example, depend on the tax consequences to the merchant that established the rewards program.

At step 120, periodically or each time a PM contributes points to the CR, the system will update the CR status to show the total number of points contributed to date. At the same time, the system will update the PM's account to show the number of RP points remaining in the PM's account following the member's contribution to the CR.

An end date reminder is e-mailed to the Administrator PM, PMs and invitees before the end date. Once the contribution end date is reached, at step 122, if the points goal has been achieved, two options are available. In one example, the points will automatically be redeemed for the predetermined reward. That is, as soon as the points goal has been reached, the system will automatically redeem the contributed points for the predetermined reward. In a second example, the Administrator PM takes the necessary steps to redeem the contributed points for the reward. At step 124, the system then sends an e-mail notification to participating PMs that the CR has been redeemed and that the RP points are no longer available to the contributing PM.

In addition, the Administrator PM may get further notifications while the CR period is still open. For example, if the number of points required to redeem the reward changes, the Administrator PM will be notified; the Administrator PM can then notify the invitees and participants to contribute points expeditiously. In another example, if the status of the Administrator PM changes while the CR period is open, so that, for example, free priority shipping becomes unavailable, the system will notify the Administrator PM of that fact.

If the termination date is approaching but the point goal has not been achieved by a predetermined time prior to the expiration date of the CR, the system will send a notification to the Administrator PM, PMs and to all invitees. The Administrator PM, PMs and/or other invitees then have the option to (a) contribute more points to achieve the point goal; (b) add additional invitees to contribute to the CR: or (c) contribute points for the first time. In another embodiment, the Administrator PM may have the option of extending the termination date for a limited period of time (e.g., several days, a week, a month, etc.).

If the CR end date is reached and the point goal has not been achieved, the system will automatically terminate the CR and the contributed points will be returned to the individual PM accounts at step 126. In that event, if the community reward is terminated without redeeming the contributed points, at step 126 the system notifies the participating PMs that the CR has been terminated without redeeming the contributed points and that the points have been returned to the contributors' respective accounts. Once the points have been returned to the respective PM accounts, the points are then available to the respective PMs to do with them as they wish.

As a variant to the above described example, the PM may only be required to indicate the number of RP points he/she intends to contribute to the CR account. In essence, the PM pledges points to the CR. At this point, the system does not withdraw the points from the PM's account nor place a hold on those points. The system updates the CR status to add the number of points the PM intends to contribute to the then pending total. If the PM desires to use some or all of those points for another purpose, then upon redemption of those points by the PM, the total of contributed points to the CR is reduced by an appropriate amount. For example, suppose the PM has 100,000 points in his/her RP account. The PM pledges to contribute 50,000 points to a CR account. However, after making the election but before the CR is redeemed, the PM decides to use 70,000 points for another purpose (e.g., to redeem the points for airline tickets). To do that, the PM needs to use 20,000 points that had been intended for the CR. Upon redemption of the points by the PM, the number of contributed points to the CR is reduced to 20,000 points, and the remaining points contributed to the CR account by that PM is 30,000 points.

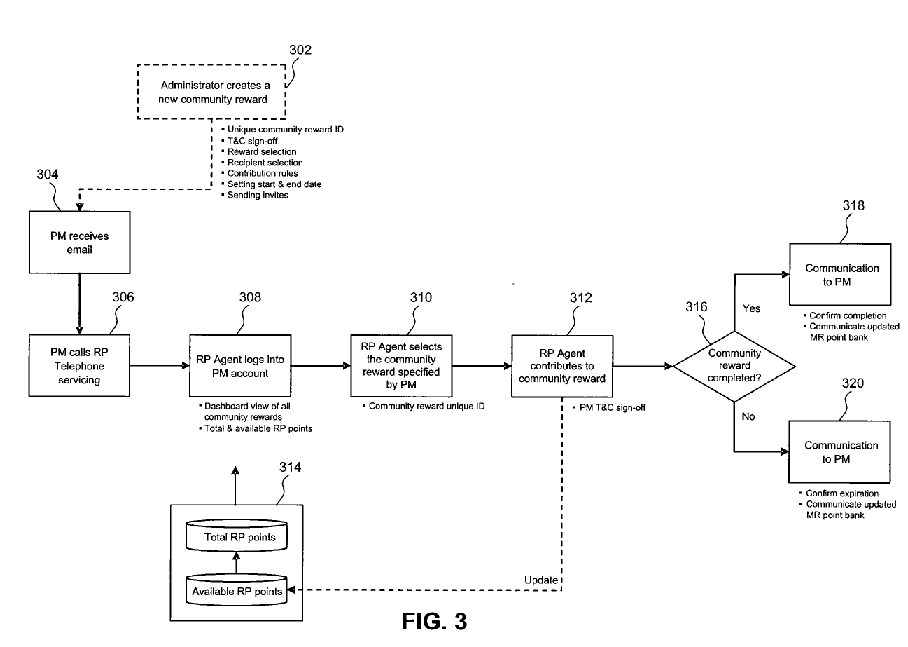

An alternate embodiment is shown in FIG. 3. In this embodiment, either or both of the creation and participation in the CR can be done by telephone. As would be appreciated by one skilled in the relevant art(s), the CR can be created by having a PM contact a reward program agent by telephone. The program agent will access the creating PM's account and create the CR. A CR created in this way (manually) will have substantially the same attributes as a CR created automatically as described above with respect to FIG. 1. However, the Administrator PM will not be able to invite others or send a personalized message to an alternate shipping recipient if the CR set up is done via telephone. Once the CR is established, the program agent will give the creating PM (now the Administrator PM) the unique CR ID number.

FIG. 3 assumes that at step 302, the Administrator PM has created the CR as described above using the manual CR set up process. A PM wishing to contribute points from his/her account to the CR then contacts a rewards program agent by telephone at step 306 and provides the program agent with the PM's account number and the CR's ID number. Alternatively, the PM could give the program agent supplementary information regarding the CR (e.g., the Administrator PM's name, billing city and state, and the purpose and recipient of the CR) if the PM does not have the CR ID number available. At step 308, the rewards program agent accesses the PM's rewards account. At step 310, the agent selects the CR specified by the PM. At step 312, the agent makes a contribution of the PM's points to the CR as specified by the PM. The agent will also confirm orally that the PM accepts the Ts&Cs of the CR before making the specified contribution. When the contribution is made, at step 314 the system updates the CR status to show the total number of points contributed to date. At the same time, the system will update the PM's account to deduct the contributed points. A confirmation email is sent to the PM after the contribution has successfully completed.

The variant described above with respect to the first embodiment is equally applicable to this second embodiment. In these variants, the contributed points can be considered as pledges. At any time prior to redemption of the CR, the pledge or any part of it can be withdrawn by the contributing PM.

It should be apparent to those skilled in the relevant arts that, in the first embodiment, an invitee can contact a program agent by phone to make a contribution. Similarly, in the second embodiment, an invitee can go on-line as described with respect to the first embodiment to make a contribution.

When the total points required for the CR has been reached, at step 316 the administrator either redeems the reward and the system communicates the redemption to the contributing PMs at step 318. If more points have been contributed to the CR than is needed to redeem the reward, the excess of contributed points will typically be returned to the contributing PMs equally.

Alternatively, if the points requirement is not achieved by the completion date, the system communicates that the reward was not redeemed and that the CR was terminated without an award, at step 320. In the former case, the points will be irrevocably deducted from the participating PM accounts; in the latter case, the points will be returned to the participating PM accounts.

In one embodiment of the present invention, the contributing member has the ability to withdraw his/her contribution before the deadline date occurs. For example, the contributing PM may decide that he/she has contributed more points than they originally intended to contribute. Or they may have a change of heart and decide that they do not wish to maintain their contribution. In such event, the contributing PM can go to the community reward site or may call the program agent to withdraw his/her contribution. Once the contribution is withdrawn, the contributed points are returned to the PM's account as though no contribution had been made. At that time, the system will update the CR status and the PM's account in a similar manner as described above.

One of the advantages of the community reward program of this embodiment is that the contributed points are not irrevocably lost to the PM once the contribution has been made. If the points goal is not reached so that the community reward is terminated without redeeming the contributed points, or, prior to the termination date the contributing member decides to withdraw his/her contribution, the contributed points are returned to the PM's account and are freely usable for future contributions or redemptions by the PM.

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of combining reward points from a plurality of individual rewards program (RP) accounts into a community reward (CR) account, comprising:
(a) establishing an on-line CR account to which program members (PMs) can contribute RP points;
(b) allowing one or more PMs to contribute RP points from their respective RP accounts to the CR account;
(c) redeeming some or all of the points in the CR account for a predetermined reward; and
(d) withdrawing the contributed points from each contributing PM's rewards account according to that PM's contribution to the CR account.

2. A method according to claim 1, further comprising:
(e) returning all unused point equitably back to each contributing PM.

3. A method according to claim 1, wherein step (a) comprises establishing an on-line community reward account that contains one or more of the following:
a CR account name or ID,
an administrator name,
a CR account start date,
a CR account expiration date,
identification of a redeemable reward from the CR account,
a number of points required for redemption of the redeemable reward, and
the current status of points contributed to the CR account.

4. A method according to claim 1, further comprising:
(e) obtaining a minimum contribution from the Administrator PM; and
(f) calculating a suggested contribution amount for each contributing PM after the minimum contribution from the Administrator PM has been obtained.

5. A method according to claim 1, further comprising:
determining when a required number of points for redemption has been contributed to the CR account.

6. A method according to claim 5, wherein step (c) further comprises automatically redeeming the reward when the required number of redemption points has been contributed to the CR account.

7. A method according to claim 5, wherein step (c) further comprises allowing the Administrator PM to determine when to redeem a reward when the required number of redemption points has been contributed to the CR account.

8. A method according to claim 1, wherein the number of RP points being contributed by a contributing PM to the CR account is individually selectable by that PM based, at least in part, on the number of RP points currently available in that PM's RP account.

9. A method according to claim 1, further comprising:
(e) returning the points contributed by the contributing PMs to their respective RP accounts in the event the CR account is terminated prior to redemption of the contributed points.

10. A method according to claim 1, further comprising:
(e) returning excess points contributed by the contributing PMs to their respective RP accounts in the event the total number of contributed points exceeds the number needed for redemption.

11. A method according to claim 1, wherein step (d) further comprises:
withdrawing the contributed points from the contributing PM's RP account upon completion of the contribution.

12. A method according to claim 11, further comprising:
placing the contributed points into an escrow account while the CR account is open.

13. For use with a rewards program (RP) established by a merchant, a method of combining reward points from a plurality of RP accounts into a community reward (CR) account, comprising:
allowing a creating program member (Administrator PM) to establish an on-line CR account containing one or more of:
a CR account name,
an administrator name,
a CR account start date,
a CR account expiration date,
identification of a redeemable reward from the CR account,
the number of points required for redemption of the redeemable reward,
the current status of points contributed to the CR account;
a minimum contribution amount of the Administrator PM,
a calculated suggested contribution amount for contributing program members (PMs),
an alternate recipient of the CR, and
a personalized message to notify the alternate recipient of the CR;
allowing one or more invitee PMs to access the CR account on-line;
allowing the one or more invitee PMs to contribute RP points from their respective RP accounts to the CR account, the number of RP points being contributed by each contributing PM being individually selectable by the respective PM based on the number of RP points currently available in that PM's RP account;
determining when the required number of points for redemption has been achieved;
redeeming some or all of the points in the CR account for a predetermined reward; and
withdrawing the redeemed points from each contributing PM's rewards account according to that PM's contribution.

14. A method according to claim 13, further comprising:
returning excess points contributed by the contributing PMs to their respective RP accounts in the event the total number of contributed points exceeds the number needed for redemption.

15. A method according to claim 13, wherein the withdrawing step further comprises:
withdrawing the contributed points from the contributing PM's RP account upon completion of the contribution.

16. A method according to claim 15, further comprising:
placing the contributed points into an escrow account while the CR account is open.

17. A method according to claim 13, further comprising:
terminating the CR account if initiated by the merchant or Administrator PM or following the expiration date in the event a required number of rewards points has not been contributed to the CR account as of the expiration date.

18. A method according to claim 13, further comprising:
returning the points contributed by the contributing PMs to their respective RP accounts in the event the CR account expires prior to redemption of the contributed points.

19. A method according to claim 13, further comprising:
returning excess points contributed by the contributing PMs to their respective RP accounts in the event the total number of contributed points exceeds the number needed for redemption.

20. A method according to claim 13, further comprising:
allowing a contributing PM to withdraw from the CR account prior to the expiration date of the CR account; and
returning the points contributed by the withdrawn PM to that PM's RP account.

21. A method according to claim 13, further comprising:
informing all invitee PMs when any one or more of the following events occurs:
the point value of the reward has changed,
when the period for contributing to the CR is within a predetermined time prior to the termination date,
when the CR has been cancelled, and
when the redemption limit in the CR account has been reached.

22. A method according to claim 13, further comprising:
informing all invitee PMs of their invitation to participate and the termination date of the CR.

23. A method according to claim 13, wherein the creating program member is designated as the administrator of the CR account.

24. A method according to claim 23, further comprising:
allowing the administrator of the CR account to extend the expiration date of the CR account.

25. A method according to claim 13, further comprising:
selecting a reward from among a predetermined number of eligible rewards.

26. For use with a rewards program (RP) established by a merchant, a method of combining reward points from a plurality of RP accounts into a community reward (CR) account, comprising:
establishing an on-line CR account containing one or more of:
a CR account name,
a CR account start date,
CR account expiration date,
identification of a redeemable reward for that CR account,
the number of points required for redemption of a redeemable reward, and
the current status of contributed points to the CR account;
a minimum contribution amount of the tartor PM
a calculated suggested contribution amount for contributing program members (PMs),
an alternate recipient of the CR, and
a personalized message to notify the alternate recipient of the CR;
allowing one or more program members (PMs) to access the CR account on-line;
allowing the one or more invitee PMs to contribute RP points from their respective RP accounts to the CR account, the number of RP points being contributed by each contributing PM being individually selectable by the respective PM based, at least in part, on the number of RP points currently available in that PM's respective RP account;
withdrawing the contributed points from each PM's respective RP account at the time the contribution is made;
determining when the required number of points for redemption has been achieved; and
redeeming some or all of the points in the CR account for a predetermined reward.

27. A method according to claim 26, further comprising:
placing the contributed points into an escrow account while the CR account is open.

28. A method according to claim 26, further comprising:
terminating the CR account if initiated by the merchant or Administrator PM or following the expiration date in the event a required number of rewards points has not been contributed to the CR account as of the expiration date.

29. A method according to claim 28, further comprising:
returning the points contributed by the contributing PMs to their respective RP accounts in the event the CR account expires prior to redemption of the contributed points.

30. A method according to claim 28, further comprising:
returning excess points contributed by the contributing PMs to their respective RP accounts in the event the total number of contributed points exceeds the number needed for redemption.

31. A method according to claim 26, further comprising:
allowing a contributing PM to withdraw from the CR account prior to the expiration date of the CR account; and
returning the points contributed by the withdrawn PM to that PM's RP account.

32. A method according to claim 26, further comprising:
informing all invitee PMs when any one or more of the following events occurs:
the point value of the reward has changed,
when the period for contributing to the CR is within a predetermined time prior to the termination date,
when the CR has been cancelled, and
when the redemption limit in the CR account has been reached.

33. A method according to claim 26, further comprising:
selecting a reward from among a predetermined number of eligible rewards.

34. A method according to claim 26, further comprising:
informing all invitee PMs of their invitation to participate and the termination date of the CR.
